(19) United States
(12) Patent Application Publication
(10) Pub. No.: US 2026/0127860 A1
(43) Pub. Date: May 7, 2026

(54) OBJECT CLASSIFICATION MODEL TRAINING METHOD, COMPUTATION DEVICE FOR TRAINING OBJECT CLASSIFICATION MODEL, OBJECT RECOGNITION DEVICE, AND OBJECT RECOGNITION METHOD

(71) Applicant: INSTITUTE FOR INFORMATION INDUSTRY, Taipei City (TW)

(72) Inventors: Ching Han Yang, Taipei City (TW); Min Di, Taipei City (TW); Li Wei Kuo, Taipei City (TW); Wei-Jen Wang, Taipei City (TW); Chia-Yu Lin, Taipei City (TW)

(73) Assignee: INSTITUTE FOR INFORMATION INDUSTRY, Taipei City (TW)

(21) Appl. No.: 19/008,819

(22) Filed: Jan. 3, 2025

(30) Foreign Application Priority Data
Nov. 4, 2024 (TW) 113142135

(51) Int. Cl. G06V 10/774; G06V 10/25; G06V 10/75; G06V 10/764; G06V 10/77; G06V 10/776; G06V 40/10

(52) U.S. Cl. CPC G06V 10/774; G06V 10/25; G06V 10/751; G06V 10/764; G06V 10/7715; G06V 10/776; G06V 40/10

(57) ABSTRACT

An object classification model training method, a computation device for training an object classification model, an object recognition device, and an object recognition method are provided. The object classification model training method comprises steps of: receiving multiple model files each respectively having a virtual object 3D model; generating multiple 2D images of each virtual object 3D model by a revolving image-capture schedule, wherein the positions of the virtual object 3D model in the multiple 2D images are different; generating a training data set for each virtual object 3D model based on the multiple 2D images of each virtual object 3D model; and training an untrained model according to the training data sets corresponding to the virtual object 3D models of the multiple model files to obtain an object classification model.

### CROSS REFERENCE TO RELATED APPLICATIONS

The present application claims priority to Taiwan application No. 113142135, filed on Nov. 4, 2024, the content of which is hereby incorporated by reference in its entirety.

### BACKGROUND OF THE INVENTION

### 1. Field of the Invention

The present application relates generally to a model training method, a computation device for model training, an object recognition device, and an object recognition method, and more particularly to an object classification model training method, a computation device for training an object classification model, an object recognition device using an object classification model, and an object recognition method thereof.

### 2. Description of Related Art

A machine is usually assembled by multiple components. For example, the machine with a relatively complicated mechanism may be assembled by hundreds of components. Hard copies of data, such as subassembly drawings of the machine, assembly drawings of the machine, diagrams of the components, specification datasheets, and so on, are provided at the site of the machine assembly. The engineer can check and review the hard copies for reference during the assembly process. However, when the engineer would like to search for the specification datasheet of a certain component or to confirm the mounting position of a certain component, the engineer has to spend a lot of time comparing the information among the hard copies during the assembly process. That would be quite bothering for the engineer.

### SUMMARY OF THE INVENTION

The objectives of the present invention are to provide an object classification model training method, a computation device for training an object classification model, an object recognition device using an object classification model, and an object recognition method thereof for resolving the trouble of checking and reviewing data from hard copies as described in the related art.

The object classification model training method of the present invention is performed by a computation device and comprises steps as follows: reading multiple model files, wherein each model file comprises a virtual object three-dimensional (3D) model; generating multiple two-dimensional (2D) images of the virtual object 3D model of each model file by a revolving image-capture schedule, wherein the multiple 2D images respectively have different contents corresponding to different positions of the virtual object 3D model of each model file; generating a training dataset according to the multiple 2D images corresponding to the virtual object 3D model of each model file; and training a to-be-trained model by the training dataset corresponding to the virtual object 3D model of each model file to obtain an object classification model.

The computation device for training an object classification model of the present invention comprises a storage and a processor. The storage stores multiple model files, wherein each model file comprises a virtual object three-dimensional (3D) model. The processor is electrically connected to the storage and performing steps as follows: reading the multiple model files from the storage; generating multiple two-dimensional (2D) images of the virtual object 3D model of each model file by a revolving image-capture schedule, wherein the multiple 2D images respectively have different contents corresponding to different positions of the virtual object 3D model of each model file; generating a training dataset according to the multiple 2D images corresponding to the virtual object 3D model of each model file; and training a to-be-trained model by the training dataset corresponding to the virtual object 3D model of each model file to obtain an object classification model.

The object recognition device of the present invention comprises an image capturing apparatus, a monitor, and a processor. The image capturing apparatus photographs a to-be-recognized object to generate an actual image having the to-be-recognized object. The processor is signally connected to the image capturing apparatus and the monitor and performs steps as follows: receiving the actual image from the image capturing apparatus; inputting the actual image to the foregoing object classification model for the object classification model to output multiple object candidates according to the to-be-recognized object of the actual image, wherein each object candidate has an accuracy; sorting the multiple object candidates according to the accuracies to generate a sort list of the multiple object candidates; and controlling the monitor to display at least one of the object candidates that has the accuracy higher than a preset ratio in the sort list.

The object recognition method of the present invention is performed by a processor and comprises steps as follows: receiving an actual image from an image capturing apparatus; inputting the actual image to the foregoing object classification model for the object classification model to output multiple object candidates according to the to-be-recognized object of the actual image, wherein each object candidate has an accuracy; sorting the multiple object candidates according to the accuracies to generate a sort list of the multiple object candidates; and controlling a monitor to display at least one of the object candidates that has the accuracy higher than a preset ratio in the sort list.

The object classification model training method and the computation device of the present invention obtain the training datasets respectively corresponding to the virtual object 3D models by automatic image capturing of the revolving image-capture schedule. It is not necessary to wait for the production of the physical components. So, introducing artificial intelligence (AI) techniques into actual fields is much easier by the present invention. In addition, the object recognition device and the object recognition method of the present invention adopt the object classification model obtained by the foregoing object classification model training method. The present invention could effectively output the object candidates by the object classification model and display the object candidates on the monitor for the user to select. Therefore, it is not necessary for the user to check and review data from hard copies as described in the related art. The present invention will assist the user in rapidly checking and reviewing the components to promote the whole working efficiency.

### BRIEF DESCRIPTION OF THE DRAWINGS

FIG. 1 is a block diagram of an embodiment of the computation device for training an object classification model of the present invention.

FIG. 2 is a schematic diagram of a virtual object 3D model of a model file of the present invention.

FIG. 3 is a flow chart of an embodiment of the object classification model training method of the present invention.

FIG. 4A is a schematic diagram of a 2D image captured from a virtual object 3D model.

FIG. 4B is a schematic diagram of a 2D image captured from the virtual object 3D model corresponding to FIG. 4A.

FIG. 4C is a schematic diagram of a 2D image captured from another virtual object 3D model.

FIG. 4D is a schematic diagram of a 2D image captured from the virtual object 3D model corresponding to FIG. 4C.

FIG. 5 is a flow chart of an embodiment of step S03 of the training method of the present invention.

FIG. 6 is a flow chart of an embodiment of step S02 of the training method of the present invention.

FIG. 7A is a schematic diagram of a 2D image showing a portion of a virtual object.

FIG. 7B is a schematic diagram of a 2D image showing a portion of another virtual object.

FIG. 8 is a block diagram of an embodiment of the object recognition device of the present invention.

FIG. 9 is a schematic diagram of an actual image photographed by the image capturing apparatus of the object recognition device of the present invention.

FIG. 10 is a block diagram of an embodiment of the object recognition device of the present invention.

FIG. 11 is a flow chart of an embodiment of the object recognition method of the present invention.

FIG. 12 is a schematic diagram of a recognition window displayed by the monitor of the object recognition device of the present invention.

FIG. 13 is a flow chart of another embodiment of the object recognition method of the present invention.

FIG. 14 is a schematic diagram of another recognition window displayed by the monitor of the object recognition device of the present invention.

FIG. 15 is a flow chart of the computation for the estimated maximum length of the to-be-recognized object in the object recognition method of the present invention.

FIG. 16 is a schematic diagram depicting a bounding box on the to-be-recognized object of the depth image of the present invention.

FIG. 17 is another schematic diagram depicting a bounding box on the to-be-recognized object of the depth image of the present invention.

### DETAILED DESCRIPTION OF PREFERRED EMBODIMENT(S)

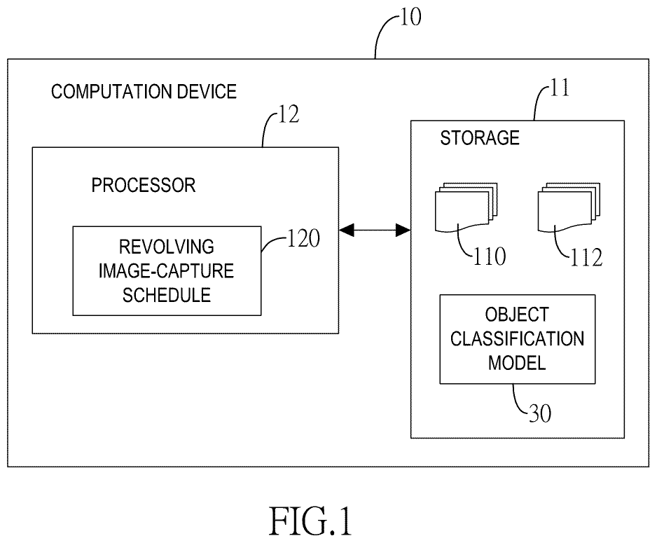

The object classification model training method of the present invention is performed by a computation device. With reference to FIG. 1, an embodiment of the computation device 10 comprises a storage 11 and a processor 12. The processor 12 is electrically connected to the storage 11. The storage 11 is configured to store data. The processor 12 can read data from the storage 11 and write data into the storage 11. For example, the storage 11 may be a computer-readable medium such as cloud storage, solid-state drive (SSD), hard-disk drive (HDD), memory, memory card, and so on. The processor 12 comprises the function of data processing. The processor 12 may be implemented by a central processing unit (CPU), a graphic processing unit (GPU), or cooperation of CPU and GPU.

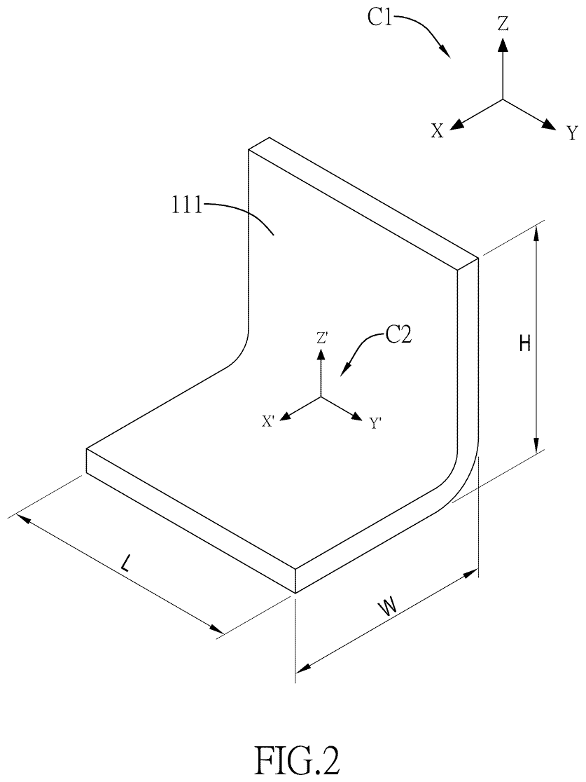

With reference to FIG. 1 and FIG. 2, the storage 11 stores multiple model files 110. The content of each model file 110 comprises a virtual object three-dimensional (3D) model 111. The file format of each model file 110 may be 3D authoring and interchange format, such as FBX (Filmbox), OBJ, GLTF/GLB, USD/USDZ, CAD, STP/STEP, DWG, DXF, BLEND, and so on. The virtual object 3D models 111 of the multiple model files 110 correspond to physical components with different model numbers or different products to be manufactured. The foregoing physical components with different model numbers may have different specifications, different appearances, and/or different functions to each other. In addition, the storage 11 stores specification data of each model file 110. For example, the specification data may comprise engineering drawing, component size, and component title.

The processor 12 is preset with a revolving image-capture schedule 120 with the purpose to capture two-dimensional (2D) images of each virtual object 3D model 111 at different positions. In an embodiment, the processor 12 may establish and execute the revolving image-capture schedule 120 by Unity® software programs. The revolving image-capture schedule 120 comprises setting values of image capturing configuration data. The image capturing configuration data comprises at least one object fixed axis, at least one axis of revolution, and at least one image capturing frequency. For example, the Unity® operating environment provides a third-person camera to capture the virtual object 3D model 111 to obtain 2D images for each virtual object 3D model 111. The virtual object 3D model 111 is established in a space coordinate system C1. The position of the virtual object 3D model 111 is defined by an object coordinate system C2 relative to the space coordinate system C1. The space coordinate system C1 and the object coordinate system C2 are rectangular coordinate systems respectively. The axes of the space coordinate system C1 are defined as X-axis, Y-axis, and Z-axis. The axes of the object coordinate system C2 are defined as X′-axis, Y′-axis, and Z′-axis. The X-axis and the Y-axis of the space coordinate system C1 form a horizontal plane. The following Table I discloses an example of the revolving image-capture schedule 120 for reference.

TABLE I

| Revolving | | | |
|---|---|---|---|
| image- | | | |
| capture | Object fixed | Axis of | |
| schedule | axis | revolution | Image capturing frequency |
| Sequence | Z′-axis at 0 | X-axis | Capturing a 2D image every |
| 1^{st} | degree | | 4 degrees of revolution |
| Sequence | Z′-axis at 0 | Y-axis | Capturing a 2D image every |
| 2^{nd} | degree | | 4 degrees of revolution |
| Sequence | Z′-axis at 45 | Y-axis | Capturing a 2D image every |
| 3^{rd} | degrees | | 4 degrees of revolution |
| Sequence | Z′-axis at 315 | Y-axis | Capturing a 2D image every |
| 4^{th} | degrees | | 4 degrees of revolution |

(The rest could be deduced or set by requirements, and thus is omitted herein)

The space coordinate system C1 is fixed as a reference coordinate system. The third-person camera of Unity® revolves around the virtual object 3D model 111 according to the axis of revolution. In any sequence of the revolving image-capture schedule 120, the third-person camera of Unity® revolves around the virtual object 3D model 111 according to the axis of revolution for a complete circle (360 degrees), and then proceeds to the next sequence. By doing so, when the last sequence is finished, the revolving image-capture schedule 120 is terminated. With reference to the foregoing Table I, in the sequence 1^{st}, the object fixed axis for the virtual object 3D model 111 is the Z′-axis at 0 degree, which means the Z′-axis of the object coordinate system C2 is perpendicular to the horizontal plane of the space coordinate system C1, and the third-person camera of Unity® revolves around the virtual object 3D model 111 as well as the X-axis (axis of revolution). For another example, in the sequence 3^{rd}, the object fixed axis for the virtual object 3D model 111 is the Z′-axis at 45 degrees, which means an angle between the Z′-axis of the object coordinate system C2 and the Z-axis of the space coordinate system C1 is 45 degrees, and the third-person camera of Unity® revolves around the virtual object 3D model 111 as well as the Y-axis (axis of revolution). According to the setting of the image capturing frequency, the third-person camera of Unity® would capture a 2D image every 4 degrees of revolution. It is understandable that the positions of the virtual object 3D model 111 captured in two adjacent 2D images are different to each other. In other words, the virtual object 3D model 111 have different rotation angles among different 2D images.

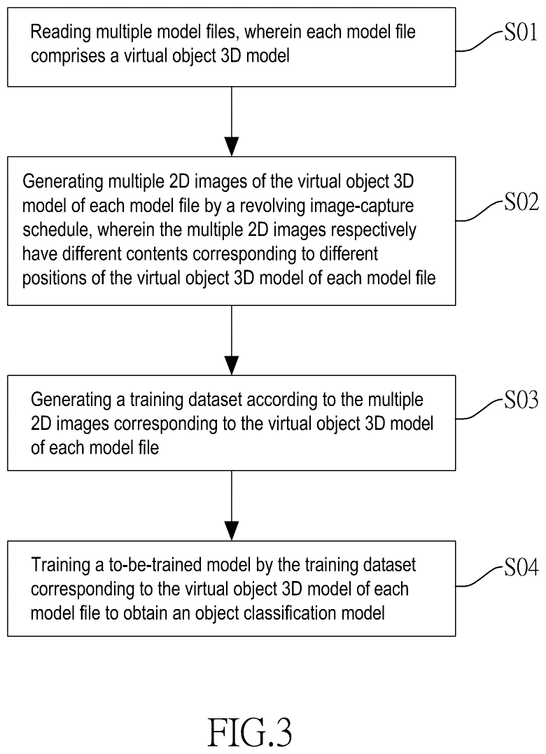

With reference to FIG. 3, an embodiment of the object classification model training method of the present invention comprises the following steps S01 to S04 that are performed by the processor 12. The steps S01 and S02 could be performed under Unity® operating environment by the processor 12.

Step S01 is to read multiple model files 110, wherein each model file 110 comprises a virtual object 3D model 111. In an embodiment, the storage 11 stores multiple model files 110, such that the processor 12 can read the multiple model files 110 from the storage 11.

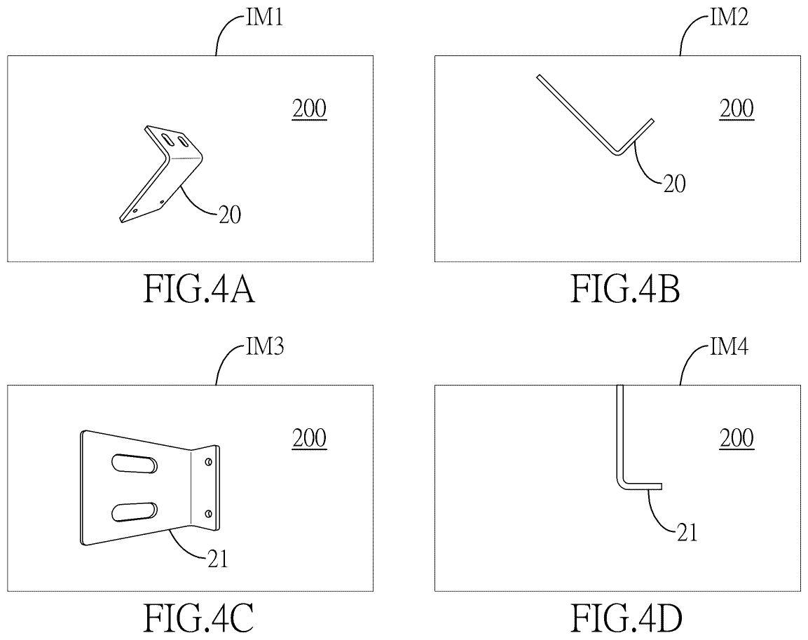

Step S02 is to generate multiple 2D images of the virtual object 3D model 111 of each model file 110 by a revolving image-capture schedule 120, wherein the multiple 2D images respectively have different contents corresponding to different positions of the virtual object 3D model 111 of each model file 110. In an embodiment, the processor 12 captures the 2D images for the virtual object 3D model 111 according to the sequences defined in the revolving image-capture schedule 120. For example, when the processor 12 finishes the 1^{st} sequence of the revolving image-capture schedule 120, the processor 12 obtains ninety frames of 2D images of the virtual object 3D model 111, and the positions of the virtual object 3D model 111 in the ninety frames of 2D images are different to one another. That is, the 2D images have different image contents respectively because the virtual object 3D model 111 has different rotation angles among the 2D images. FIG. 4A and FIG. 4B depict two 2D images IM1, IM2 of one virtual object 3D model. FIG. 4CA and FIG. 4D depict two 2D images IM3, IM4 of another different virtual object 3D model. The image content of each 2D image IM1,IM2,IM3,IM4 comprises a virtual object 20 and a background 200.

Step S03 is to generate a training dataset 112 according to the multiple 2D images corresponding to the virtual object 3D model 111 of each model file 110. In an embodiment, the processor 12 stores the multiple 2D images of each virtual object 3D model 111 obtained in the step S02 to the storage 11 as the training dataset 112.

Step S04 is to train a to-be-trained model by the training dataset 112 corresponding to the virtual object 3D model 111 of each model file 110 to obtain an object classification model 30. In an embodiment, the processor 12 reads the training datasets 112 of the model files 110 and inputs the training datasets 112 to the to-be-trained model respectively to train the to-be-trained model. After training, the object classification model 30 is formed. In other words, the object classification model 30 is the training result of the to-be-trained model. The program data of the object classification model 30 may be stored in the storage 11. The processor 12 executing the program data of the object classification model 30 can recognize components.

In order to make each virtual object 3D model 111 adequately understandable by the object classification model 30, the revolving image-capture schedule 120 of the above-mentioned step S02 will provide multiple 2D images of different positions of each virtual object 3D model 111, and such 2D images will be stored as the training dataset 112. So, the object classification model 30 can recognize the certain component from a certain position image of the component. The program data of the object classification model 30 may be stored in the storage 11 for the processor 12 to access and execute. The training principle for the object classification model 30 is common knowledge in the related art and is not the focus of the present invention, such that the training principle is not described in detail herein. For example, the object classification model 30 may be CNN-based Classifier Model or make use of neural network architecture of You Only Look Once (YOLO), Visual Geometry Group (VGG), and so on.

In the step S03, the processor 12 may perform Data Augmentation to each 2D image for creating much more training samples, so as to increase the amount of data of the training dataset 112 and to promote the training effect of the step S04. For example, the foregoing Data Augmentation is an image processing, such as random scaling, rotating, shifting, flipping over, and so on, to each 2D image to create new 2D images as training samples.

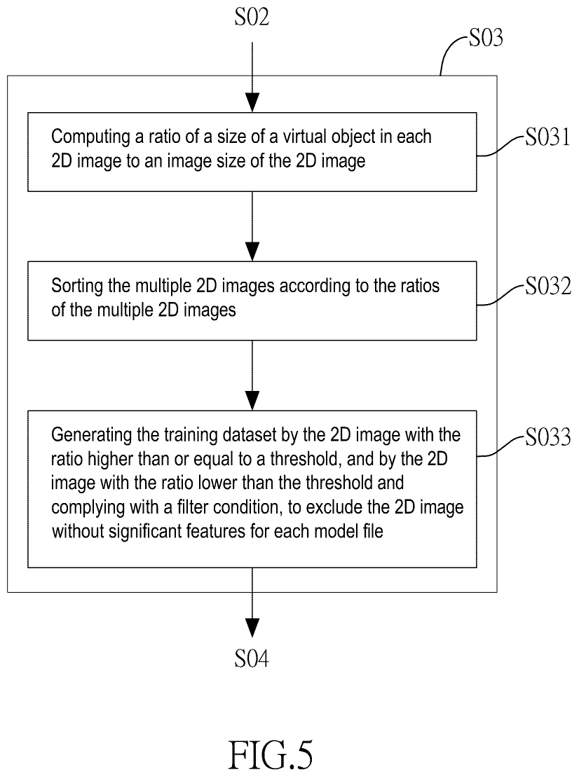

With reference to FIG. 5, in an embodiment of the object classification model training method of the present invention, the step S03 further comprises steps S031, S032, and S033 to remove the 2D image without significant features and then generate the training dataset 112. By doing so, the model training in the step S04 will not be confused by the 2D image without significant features to promote the training effect. The steps S031,S032,S033 are described as follows.

Step S031 is to compute a ratio of a size of a virtual object in each 2D image to an image size of the 2D image. In an embodiment, each 2D image is formed by pixels. The processor 12 may obtain the total number of the pixels (hereinafter referred to as an image pixel number) of each 2D image. The image pixel number of the 2D image corresponds to the image size of the 2D image. The image size of the 2D image may be represented as m×n, wherein m and n are positive integers. The image pixel number is the product of m and n. In addition, the processor 12 may obtain the pixel value of each pixel of the 2D image. Understandably, the pixel value defines the color. The processor 12 defines a background and a virtual object from each 2D image according to the pixel values of the pixels of the 2D image. With reference to FIG. 4A as an example, the 2D image IM1 comprises the background 200 and the virtual object 20, wherein the image content of the virtual object 20 is a state of the foregoing virtual object 3D model 111 at a certain position. Besides, in the 2D image IM1 of FIG. 4A, the pixel values of the background 200 are 0, and the pixel values of the virtual object 20 are higher than 0. The processor 12 can compute the number (hereinafter referred to as an object pixel number) of pixels whose pixel values are higher than 0 as the size of the virtual object 20. The object pixel number will reflect the area occupied by the virtual object 20 in the 2D image IM1.

Therefore, for each 2D image, the processor 12 can divide the object pixel number by the image pixel number to obtain the above-mentioned ratio, which can be represented as “object pixel number÷image pixel number=ratio”. Each 2D image corresponds to its own ratio.

Step S032 is to sort the multiple 2D images according to the ratios of the multiple 2D images. As mentioned above, the storage 11 stores the multiple 2D images of the virtual object 3D models 111 of the model files 110. In an embodiment, the processor 12 may store each 2D image in a folder and set a filename to each 2D image. So, the folder stores all of the 2D images captured from the virtual object 3D models 111 of the multiple model files 110, and the filenames of the 2D images are different from one another. Because each 2D image corresponds to its own ratio as described above, the processor 12 can sort the 2D images according to the magnitudes of the ratios of the multiple 2D images. For example, the processor 12 may add a serial number to the filename of each 2D image. The serial number is a positive integer higher than 0. The serial number in the filename of the 2D image corresponding to the lowest ratio may be defined as a lowest value, such as 1. The serial number in the filename of the 2D image corresponding to the highest ratio may be defined as a highest value, such as 360. Hence, the order of the serial numbers (from low to high) of the filenames represents the order of the files of the 2D images by their ratios (from low to high).

Step S033 is to generate the training dataset by the 2D image with the ratio higher than or equal to a threshold, and by the 2D image with the ratio lower than the threshold and complying with a filter condition, to exclude the 2D image without significant features from the training dataset 112 for each model file. In an embodiment, the processor 12 is preset with the threshold. The processor 12 determines whether the ratio of each 2D image is higher than or equal to the threshold, and determines whether the 2D image whose ratio is lower than the threshold complies with the filter condition. The image capturing configuration data of the revolving image-capture schedule 120 further comprises information of the filter condition. The filter condition may be a preset specific code. The specific code may be a character or a string of characters for defining special components, such as a big-size component. Hence, the processor 12 may determine whether the filename of the 2D image whose ratio is lower than the threshold includes the specific code. When the filename of the 2D image whose ratio is lower than the threshold includes the specific code, the processor 12 would determine such 2D image complies with the filter condition. Therefore, the processor 12 generates the training dataset 112 by the 2D image with the ratio higher than or equal to the threshold, and by the 2D image with the ratio lower than the threshold and complying with the filter condition. In other words, the 2D image with the ratio lower than the threshold and not complying with the filter condition will be excluded from the training dataset 112. As the foregoing example, the 2D images IM1,IM3 of FIG. 4A and FIG. 4C are retained in the training dataset 112 because their ratios are higher than or equal to the threshold, but the 2D images IM2,IM4 of FIG. 4B and FIG. 4D are excluded from the training dataset 112. As a result, the training dataset 112 does not have the 2D images IM2,IM4 because their ratios are lower than the threshold. Although the virtual objects 20,21 in the 2D images IM2,IM4 are different to each other, they still do not have obvious distinction (no significant features).

As mentioned above, the training dataset 112 has excluded the 2D images without significant features after the processor 12 performs the steps S031,S032,S033. The model training in the step S04 will not be confused by the 2D images without significant features to promote the training effect.

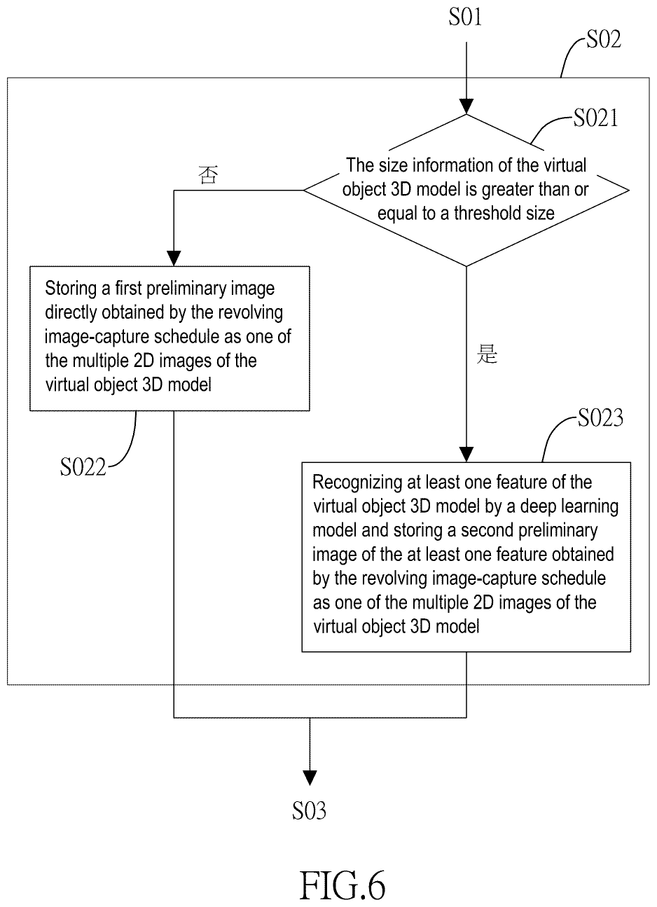

As mentioned above, a 2D image comprises a background and a virtual object. The image content of the virtual object is a state of the virtual object 3D model at a certain position. In an embodiment of the object classification model training method of the present invention, considering a virtual object 3D models with a large model size, when the 2D image includes the whole virtual object, the size of the virtual object in the 2D image has to be shrunk (known as “zoom out”). However, the features of the shrunk virtual object become smaller and insignificant, which is not conducive to the training effect of the step S04. In order to overcome the foregoing issue, in the step S01 that the processor 12 reads the multiple model files 110, the specification data of the model files 110 comprise size information of the virtual object 3D models 111 respectively. With reference to FIG. 2 for example, the size information comprises an overall length L (such as the longest length), an overall width W (such as the widest width), and an overall height H (such as the highest height). With reference to FIG. 6, the step S02 further comprises steps S021, S022, and S023. The step S022 is adapted for the virtual object 3D models of non-large components. The step S023 is adapted for the virtual object 3D models of large components. The steps S021,S022,S023 are described as follows.

Step S021 is to determine whether the size information of each virtual object 3D model 111 is greater than or equal to a threshold size. In an embodiment, the processor 12 is preset with setting values of the threshold size. The threshold size may comprise a length threshold, a width threshold, and a height threshold. In the step S021, the processor 12 determines whether the overall length L of the virtual object 3D model 111 is longer than or equal to the length threshold, determines whether the overall width W of the virtual object 3D model 111 is wider than or equal to the width threshold, and determines whether the overall height H of the virtual object 3D model 111 is higher than or equal to the height threshold.

If the determination result of the step S021 is NO, the processor 12 will proceed to the step S022 to store an image (hereinafter referred to as a first preliminary image) directly obtained by the revolving image-capture schedule 120 as one of the multiple 2D images of the virtual object 3D model 111. In an embodiment, when the processor 12 determines that the overall length L, the overall width W, and the overall height H are shorter, narrower, and lower than the length threshold, the width threshold, and the height threshold respectively, the determination result of the step S021 is NO, which means the virtual object 3D model 111 is not the large component. So, the processor 12 stores each frame of image (as the foregoing first preliminary image) directly obtained by the revolving image-capture schedule 120 as one of the multiple 2D images of the virtual object 3D model 111. That is, the first preliminary image is a frame of 2D image directedly captured by the revolving image-capture schedule 120 executed by the processor 12. The image content of the first preliminary image contains a whole virtual object (as shown in FIG. 4A and FIG. 4C).

If the determination result of the step S021 is YES, the processor 12 will proceed to the step S023 to recognize at least one feature of the virtual object 3D model by a deep learning model and to store an image (hereinafter referred to as a second preliminary image) of the at least one feature obtained by the revolving image-capture schedule as one of the multiple 2D images of the virtual object 3D model. In an embodiment, when the processor 12 determines that at least one of the overall length L, the overall width W, and the overall height H is shorter, narrower, or lower than the corresponding length threshold, width threshold, and height threshold, the determination result of the step S021 is YES, which means the virtual object 3D model 111 is the large component. So, this embodiment would just capture the 2D image for a feature portion of the virtual object 3D model 111.

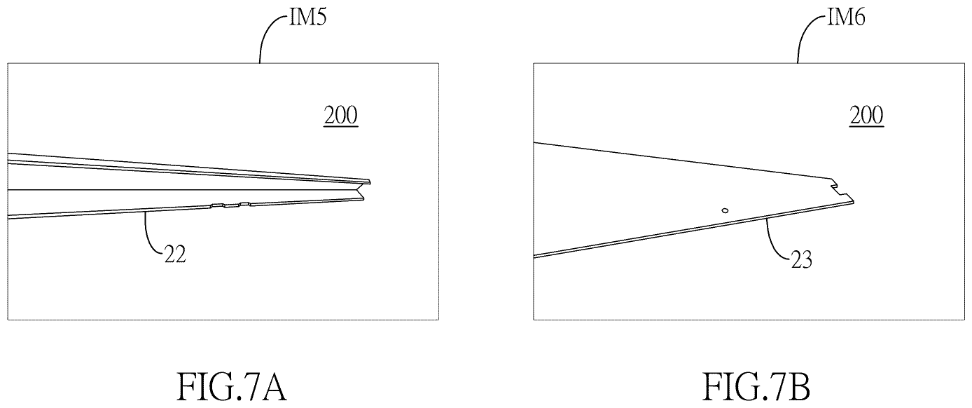

In an embodiment, the processor 12 may execute program data of the deep learning model (not shown in the drawings) and input the virtual object 3D model 111 to the deep learning model, wherein the deep learning model is the application of the conventional art. So, the deep learning model will automatically recognize information of at least one feature of the virtual object 3D model 111 and output the coordinates of the at least one feature. The processor 12 zooms in the virtual object 3D model 111 according to the coordinates of the at least one feature, and then the processor 12 captures the images from the virtual object 3D model 111 and stores each frame of the images (as the foregoing second preliminary image) as one of the multiple 2D images of the virtual object 3D model 111. That is, the second preliminary image is a frame of 2D image captured by the revolving image-capture schedule 120 executed by the processor 12. The image content of the second preliminary image is a portion that corresponds to the feature of the virtual object. For example, FIG. 7A discloses a 2D image IM5 of a virtual object 3D model of a large component, and FIG. 7B discloses a 2D image IM6 of a virtual object 3D model of another different large component. The image contents of the 2D images IM5,IM6 are the portions 22,23 of the virtual objects. The image contents of the portions 22,23 correspond to the features of the virtual objects respectively and are shown as enlarged views of the virtual object 3D model at certain positions.

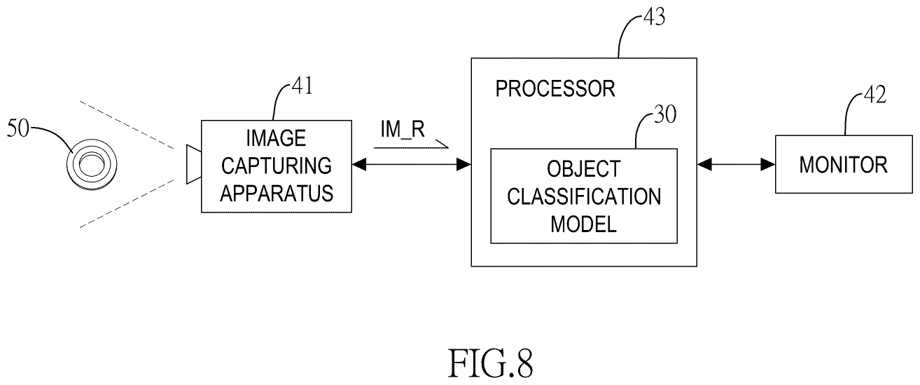

With reference to FIG. 8, an embodiment of the object recognition device of the present invention comprises an image capturing apparatus 41, a monitor 42, and a processor 43.

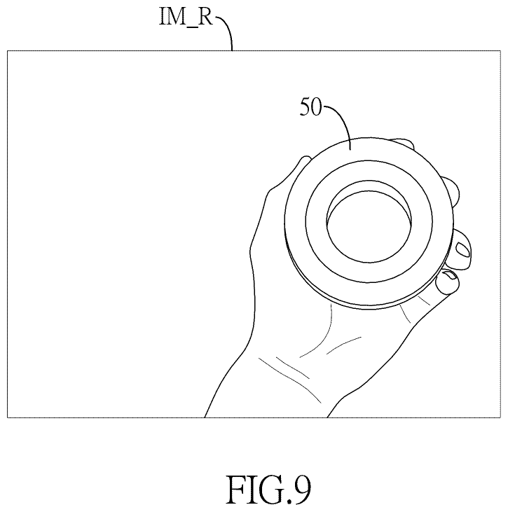

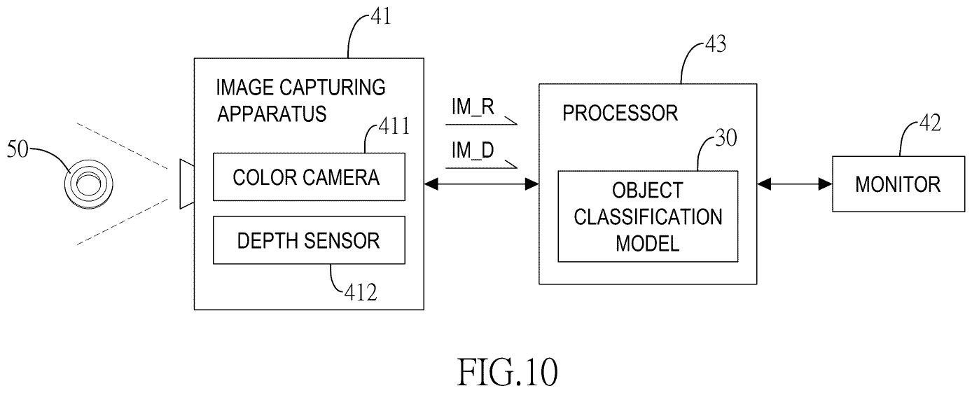

With reference to FIG. 8 and FIG. 9, the image capturing apparatus 41 is configured to photograph a to-be-recognized object 50 to generate an actual image IM_R having the to-be-recognized object 50. The actual image IM_R is a 2D image. In the actual image IM_R shown in FIG. 9, the to-be-recognized object 50 is the physical component as mentioned above (such as the non-large component and/or the large component). In an embodiment, with reference to FIG. 10, the image capturing apparatus 41 may comprise a color camera 411 to photograph the to-be-recognized object 50 to generate the actual image IM_R. The actual image IM_R has color pixel values (Red-Green-Blue, RGB).

The monitor 42 is configured to display information for the user to watch. For example, the monitor 42 may be a liquid crystal display (LCD), an organic light emitting diode display (OLED display), a transparent display, and so on.

The processor 43 is signally connected to the image capturing apparatus 41 and the monitor 42. The processor 43 comprises the function of data processing. The processor 43 may be implemented by a central processing unit (CPU), a graphic processing unit (GPU), or cooperation of CPU and GPU. The connection between the processor 43 and the image capturing apparatus 41 as well as the monitor 42 may be wired connection (such as by cable) or wireless connection (such as by wireless communication).

In an embodiment, the processor 43 communicates with the color camera 411. The image capturing apparatus 41 and the monitor 42 may be mounted on a mixed-reality (MR) headset. The field of view of the color camera 411 is almost the same as the user's eye view. So, when the user looks at the to-be-recognized object 50, the image capturing apparatus 41 can also photograph the to-be-recognized object 50, such that the image content of the actual image IM_R includes the to-be-recognized object 50. The monitor 42 may be the transparent display. The processor 43 may be mounted in a computer or a server for data transmission with the image capturing apparatus and the monitor 42.

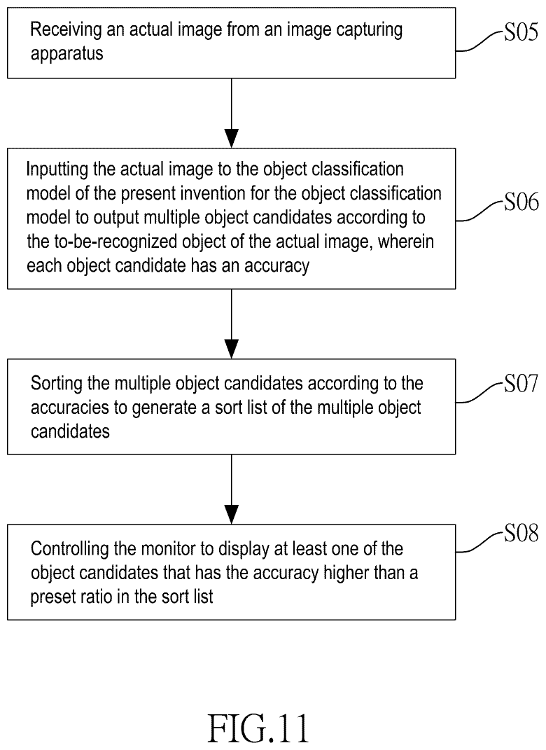

With reference to FIG. 11, an embodiment of the object recognition method of the present invention is performed by the processor 43 and comprises steps S05, S06, S07, and S08 described as follows.

Step S05 is to receive the actual image IM_R from the image capturing apparatus 41. In an embodiment, the processor 43 receives the actual image IM_R from the color camera 411 of the image capturing apparatus 41. The actual image IM_R includes the image content of the to-be-recognized object 50. The actual image IM_R is a 2D image.

Step S06 is to input the actual image IM_R to the object classification model 30, obtained by the above-mentioned object classification model training method of the present invention, to output multiple object candidates according to the to-be-recognized object 50 of the actual image IM_R, wherein each object candidate has a value of an accuracy. In an embodiment, the processor of the object recognition device may communicate with the forgoing storage 11 to access and execute the program data of the object classification model 30. The input of the object classification model 30 includes the to-be-recognized object 50 of the actual image IM_R. The output of the object classification model 30 includes the multiple object candidates. The multiple object candidates correspond to a part of the forgoing model files 110. In other words, the object classification model 30 can only recognize a part of the model files 110 to be the object candidates according to the image information of the to-be-recognized object 50 of the actual image IM_R. The other part of the model files 110 are not recognized by the object classification model 30. The recognition principle of the object classification model 30 as well as the generation of the accuracy are common knowledge in the related art and are not the focus of the present invention, such that they are not described in detail herein. For example, the object classification model 30 may be CNN-based Classifier Model or make use of neural network architecture of You Only Look Once (YOLO), Visual Geometry Group (VGG), and so on.

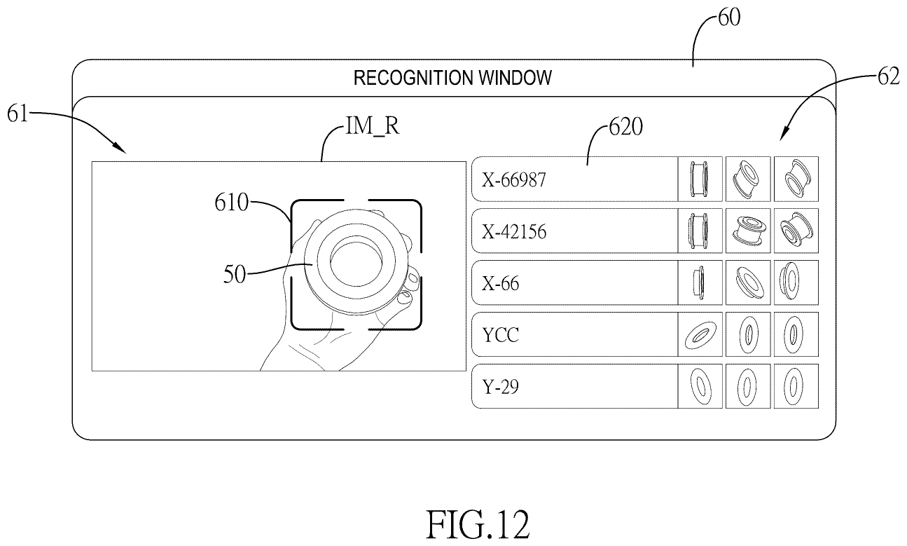

As the foregoing example of the MR headset, with reference to FIG. 12, the processor 43 may control the monitor 42 to display a recognition window 60. The recognition window 60 comprises an image field 61 configured to display the actual image IM_R in real-time. The image field 61 has a recognition indicator 610 with a range displayed as the square frame and defined by image coordinates. The processor 43 recognizes the to-be-recognized object 50 within the recognition indicator 610 of the actual image IM_R to output the multiple object candidates.

Step S07 is to sort the multiple object candidates according to the accuracies of the multiple object candidates to generate a sort list of the multiple object candidates. In an embodiment, the processor 43 may arrange the object candidate with the highest accuracy to the top of the sort list, and arrange the object candidate with the lowest accuracy to the bottom of the sort list. So, the multiple object candidates in the sort list are in a descending order according to the magnitudes of the accuracies. The following Table II shows an example of the sort list for reference. The object classification model 30 just recognizes ten object candidates. The object candidate “X-66987” is arranged to the top of the sort list. The object candidate “L-341” is arranged to the bottom of the sort list. The “Reference length” in the Table II will be described as follows.

TABLE II

| | | Reference length |
|---|---|---|
| Object candidate | Accuracy (%) | (centimeter) |
| X-66987 | 85 | 60 |
| X-42156 | 83 | 25 |
| X-66 | 80 | 50 |
| YCC | 78 | 50 |
| Y-29 | 76 | 8 |
| ZZ986 | 72 | 55 |
| UPSIDE-5 | 69 | 10 |
| UPSIDE-9 | 65 | 45 |
| SNN-6524 | 62 | 32 |
| L-341 | 60 | 5 |

Step S08 is to control the monitor 42 to display at least one of the object candidates that has the accuracy higher than a preset ratio in the sort list. In an embodiment, the processor 43 is preset with the preset ratio. With reference to FIG. 12, the recognition window 60 comprises a candidate field 62 beside the image field 61. The processor 43 controls the monitor 42 to display option(s) in the candidate field 62, wherein the option(s) correspond(s) to the at least one object candidate 620 that has the accuracy higher than the preset ratio in the sort list. As shown in Table II for example, when the preset ratio is 75%, the candidate field 62 may just display five options of the five object candidates “X-66987”, “X-42156”, “X-66”, “YCC”, and “Y-29” whose accuracies are higher than the preset ratio of 75%, as shown in FIG. 12.

Therefore, when the user sees the options of the object candidates 620 listed in the candidate field 62, the user may input a selection command to the processor 43. According to the selection command, the processor 43 reads the specification data corresponding to the selected object candidates 620 from the storage 11 and controls the monitor 42 to display such specification data. As the foregoing example of the MR headset, the MR headset may have the function of gesture recognition. The processor 43 may receive information of a recognized gesture as the selection command to determine the selected object candidates 620 corresponding to the selection command.

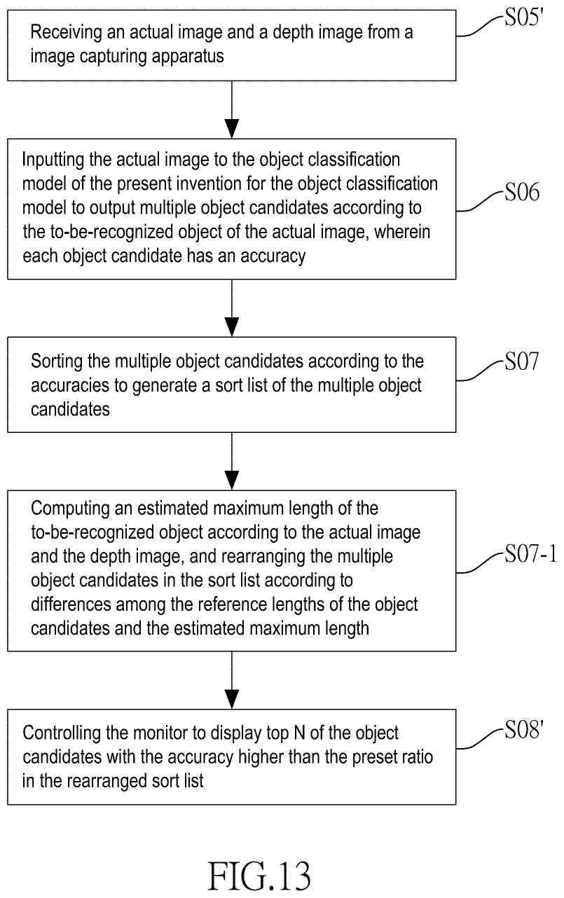

To improve the accuracy for finding out the object candidates 620, with reference to FIG. 10 and FIG. 13, an embodiment of the object recognition method of the present invention is to receive a depth image IM_D (Step S05′ shown in FIG. 13) from the image capturing apparatus 41 by the processor 43, such that the processor 43 further performs steps S07-1 after the foregoing step S07, described as follows.

In an embodiment, the specification data of each model file 110 comprises a reference length (as described in the foregoing Table II). The reference length may be defined as the overall length L in the specification data. Because each object candidate 620 corresponds to a certain model file 110, each object candidate 620 is deemed to have the corresponding reference length.

In an embodiment, with reference to FIG. 10, the image capturing apparatus 41 comprises the color camera 411 and a depth sensor 412. The depth sensor 412 may be a depth camera. The depth sensor 412 senses (photographs) the to-be-recognized object 50 to generate a depth image IM_D including the to-be-recognized object 50. The field of view of the color camera 411 is almost the same as the field of view of the depth sensor 412, such that the color camera 411 and the depth sensor 412 may photograph the to-be-recognized object 50 by the corresponding field of view at the same time, and both the actual image IM_R and the depth image IM_D include the image content of the to-be-recognized object 50. The processor 43 communicates with the color camera 411 and the depth sensor 412 to receive the actual image IM_R and the depth image IM_D respectively photographed by the color camera 411 and the depth camera 412 at the same time (as step S05′ of FIG. 13).

Step S07-1 is to compute an estimated maximum length of the to-be-recognized object 50 according to the actual image IM_R and the depth image IM_D, and to rearrange the multiple object candidates in the sort list according to differences among the reference lengths of the object candidates and the estimated maximum length. After the sort list is rearranged, the processor 43 controls the monitor 42 to display top N of the object candidates with the accuracy higher than the preset ratio in the rearranged sort list (as step S08′ of FIG. 13), wherein N is a preset number and is a positive integer higher than or equal to 1. In an embodiment, when the processor 43 obtains the actual image IM_R and the depth image IM_D, the processor 43 computes an estimated maximum length of the to-be-recognized object 50 according to the information of the actual image IM_R and the depth image IM_D. The computation for the estimated maximum length by the processor 43 will be described as follows.

The approach to rearrange the sort list by the processor 43 is described herein. As mentioned above, after the processor 43 finishes the step S07, the multiple object candidates in the sort list are in a descending order according to the magnitudes of their accuracies (as shown in the foregoing Table II). In an embodiment, a difference between the reference length of each object candidate and the estimated maximum length is defined as an absolute difference value. The processor 43 rearranging the multiple object candidates in the sort list is to determine whether the absolute difference value between the reference length of each object candidate and the estimated maximum length is lower than or equal to an error upper limit, wherein the error upper limit is a preset value. For example, when the processor 43 computes the estimated maximum length of the to-be-recognized object 50 is fifty centimeters and the error upper limit is fifteen, the absolute difference values respectively corresponding to the object candidates are shown in the following Table III.

TABLE III

| | | Reference length | Absolute |
|---|---|---|---|
| Object candidate | Accuracy (%) | (centimeter) | difference value |
| X-66987 | 85 | 60 | 10 |
| X-42156 | 83 | 25 | 25 |
| X-66 | 80 | 50 | 0 |
| YCC | 78 | 50 | 0 |
| Y-29 | 76 | 8 | 42 |
| ZZ986 | 72 | 55 | 5 |
| UPSIDE-5 | 69 | 10 | 40 |
| UPSIDE-9 | 65 | 45 | 5 |
| SNN-6524 | 62 | 32 | 18 |
| L-341 | 60 | 5 | 45 |

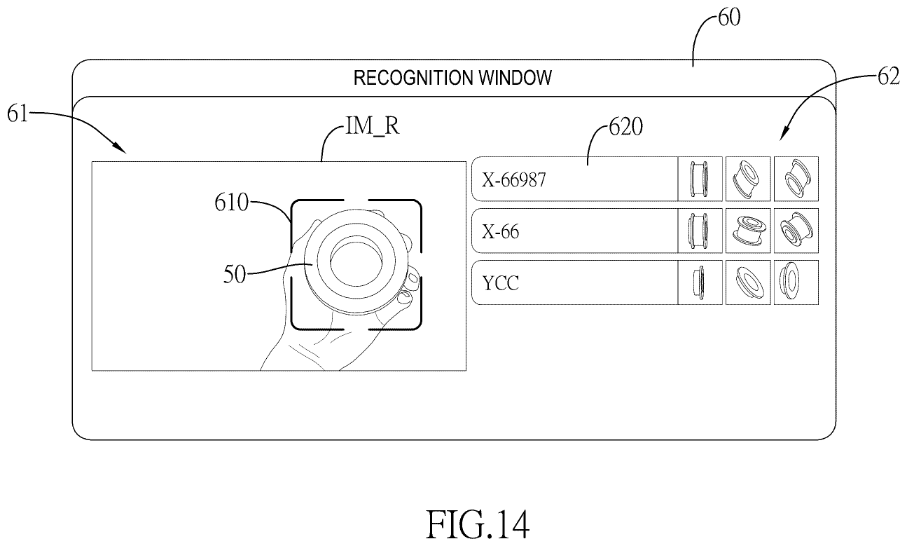

Therefore, the processor 43 firstly computes the absolute difference 8 value of the object candidate “X-66987” is ten, which is lower than or equal to the error upper limit (fifteen). So, the processor 43 retains the position of the object candidate “X-66987” in the sort list. Then, the processor 43 computes the absolute difference value of the next object candidate “X-42156” is twenty-five, which is not lower than or equal to the error upper limit (fifteen). So, the processor 43 arranges such object candidate “X-42156” to the bottom of the sort list, and the rest object candidates are moved upwards accordingly to fill the vacancy. The determination and arrangement for the next object candidate “X-66” to the last object candidate “L-341” could be deduced from the foregoing description. As a result, the original sort list (Table II) is rearranged to be the following Table IV. The processor 43 controls the monitor 42 to display top N object candidate(s) with the accuracy higher than the preset ratio (75% as the foregoing example) in the rearranged sort list (as the following Table IV). For example, N is 3. With reference to FIG. 14, the processor 43 controls the monitor 42 to just display the three options of the object candidates “X-66987”, “X-66”, and “YCC” in the candidate field 62.

TABLE IV

| | | Reference length |
|---|---|---|
| Object candidate | Accuracy (%) | (centimeter) |
| X-66987 | 85 | 60 |
| X-66 | 80 | 50 |
| YCC | 78 | 50 |
| ZZ986 | 72 | 55 |
| UPSIDE-9 | 65 | 45 |
| X-42156 | 83 | 25 |
| Y-29 | 76 | 8 |
| UPSIDE-5 | 69 | 10 |
| SNN-6524 | 62 | 32 |
| L-341 | 60 | 5 |

The step S07-1 to rearrange the sort list and the display condition of the step S08′ can move the options of the object candidates, with similar appearances but inconsistent sizes, to the lower section of the sort list not to be displayed, so as to comparatively improve the accuracy of the options shown in the candidate field 62. It is easier for the user to see the right object candidate in the candidate field 62. For example, the accuracy of the object candidate “X-42156” in Table II is 83%, which means the appearance of “X-42156” is similar to the to-be-recognized object 50. However, there is a big difference in size between the object candidate “X-42156” and the to-be-recognized object 50. The object candidate “X-42156” does not correspond to the to-be-recognized object 50 obviously. As a result, the option of the object candidate “X-42156” would be arranged to the rear section of the sort list not to be displayed.

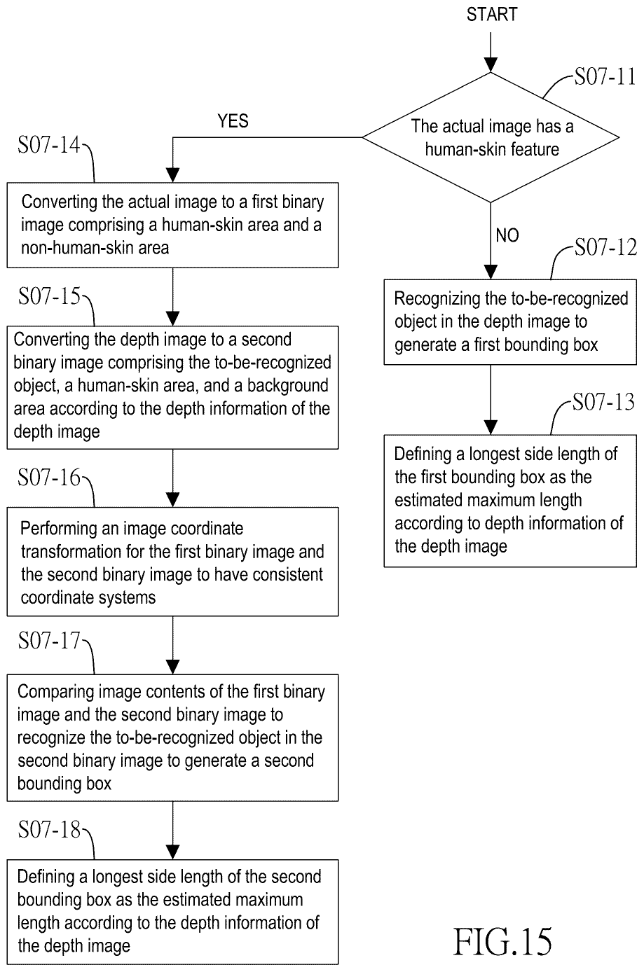

With reference to FIG. 15, the step of computing the estimated maximum length of the to-be-recognized object 50 according to the actual image IM_R and the depth image IM_D by the processor 43 comprises steps S07-11 to S07-18 described as follows.

Step S07-11 is to determine whether the actual image IM_R has a human-skin feature. In an embodiment, the processor 43 may perform program data of Human-skin detection algorithm to determine whether the actual image IM_R has the human-skin feature.

When the processor 43 determines the actual IM_R image does not have the human-skin feature (the determination result of the step S07-11 is NO), which means the to-be-recognized object 50 is placed on the ground or on the desk, and the user does not take the to-be-recognized object 50 by hands while the image capturing apparatus is photographing it, the processor 43 then performs the following steps S07-12 and S07-13.

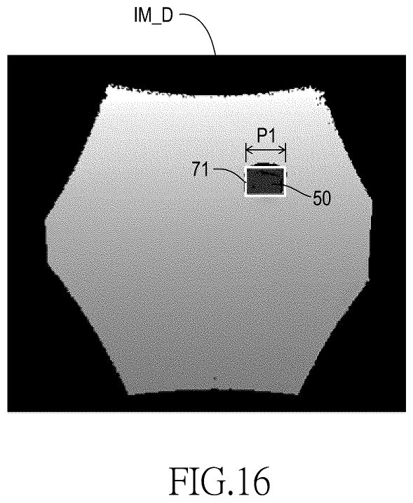

Step S07-12 is to recognize the to-be-recognized object 50 in the depth image IM_D to generate a first bounding box for the to-be-recognized object 50. For example, with reference to FIG. 16, the image content of the depth image IM_D comprises the to-be-recognized object 50. The processor 43 may perform program data of Bounding box algorithm to the depth image IM_D to generate a bounding box (hereinafter referred to as the first bounding box 71) on the to-be-recognized object 50 of the depth image IM_D. The first bounding box 71 is a rectangular box. The size of the first bounding box 71 approximately corresponds to the size of the to-be-recognized object 50.

Step S07-13 is to define a longest side length of the first bounding box 71 as the estimated maximum length according to depth information of the depth image IM_D. Understandably, the depth image IM_D comprises the depth information for the pixels. The depth information represents the relative distance between the depth sensor 412 and the to-be-recognized object 50. With reference to FIG. 16, the first bounding box 71 has a longest side length P1. For example, the first bounding box 71 is a rectangular box comprising a long side and a short side. The length of the long side is defined as the longest side length P1. Another example of the first bounding box 71 is a square box, such that the length of any side of the square box could be defined as the longest side length P1. Therefore, the processor 43 can compute the estimated maximum length of the to-be-recognized object 50 according to the depth information of the pixels on the longest side length P1 in the depth image. IM_D.

When the processor 43 determines the actual image IM_R has the human-skin feature (the determination result of the step S07-11 is YES), the processor 43 performs the following steps S07-14 to S07-18.

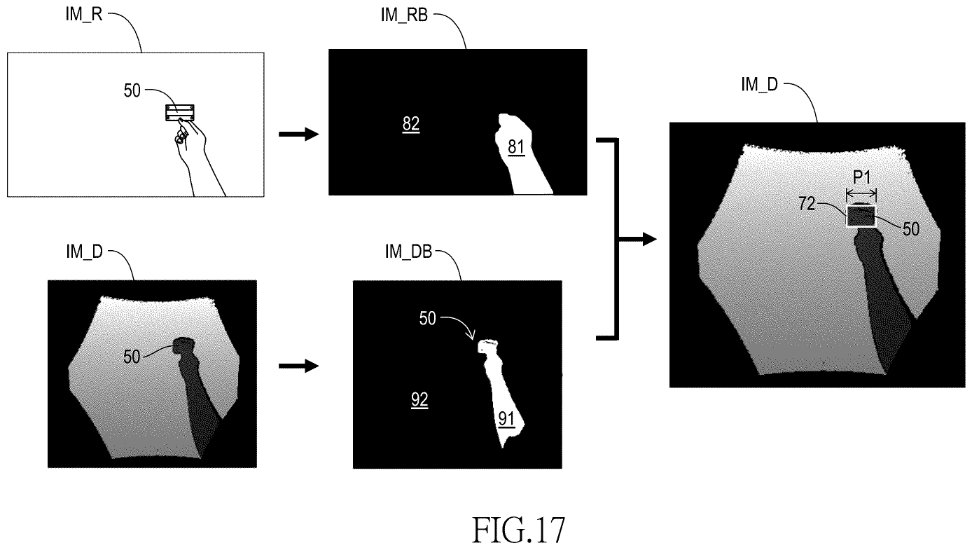

Step S07-14 is to convert the actual image IM_R to a first binary image comprising a human-skin area and a non-human-skin area. In an embodiment, with reference to FIG. 17, the processor 43 performs the binary conversion (application of the conventional art) for the actual image IM_R according to the pixels of the foregoing human-skin feature to generate the first binary image IM_RB. The first binary image IM_RB comprises a human-skin area 81 and a non-human-skin area 82.

Step S07-15 is to convert the depth image IM_D to a second binary image comprising the to-be-recognized object, a human-skin area, and a background area according to the depth information of the depth image IM_D. In an embodiment, the processor 43 performs the binary conversion for the depth image IM_D according to a depth threshold. The depth threshold is a preset value. Because the depth image IM_D comprises the depth information for the pixels, the pixels in the depth image IM_D with the depth information lower than or equal to the depth threshold represent the user's hand and the to-be-recognized object thereon. In contrast, the pixels in the depth image IM_D with the depth information higher (farther) than the depth threshold represent the background. So, with reference to FIG. 17, the second binary image IM_DB comprises the to-be-recognized object 50, the human-skin area 91, and the background area 92.

Step S07-16 is to perform an image coordinate transformation for the first binary image IM_RB and the second binary image IM_DB to have consistent coordinate systems. In an embodiment, the first binary image IM_RB and the second binary image IM_DB are photographed by the color camera 411 and the depth camera 412 respectively. Although the fields of views of the color camera 411 and the depth camera 412 are almost the same, the image contents such as scales are still different. With reference to FIG. 17 for example, the human-skin area 81 in the first binary image IM_RB is thicker than the human-skin area 91 of the second binary image IM_DB. Therefore, the processor 43 performs program data of Image coordinate transformation (application of the conventional art) for the first binary image IM_RB and the second binary image IM_DB to have consistent coordinate systems. By doing so, the human-skin area 81 in the first binary image IM_RB is consistent with the human-skin area 91 of the second binary image IM_DB in scale.

Step S07-17 is to compare image contents of the first binary image and the second binary image to recognize the to-be-recognized object in the second binary image to generate a second bounding box for the to-be-recognized object. Because the human-skin area 81 in the first binary image IM_RB is consistent with the human-skin area 91 of the second binary image IM_DB in scale as mentioned above, the processor 43 could compare the image contents of the first binary image IM_RB and the second binary image IM_DB. With reference to FIG. 17, the difference between the first binary image IM_RB and the second binary image IM_DB is the area of the to-be-recognized object 50. The processor 43 generates the second bounding box 72 in the second binary image IM_DB according to the coordinates of the difference between the first binary image IM_RB and the second binary image IM_DB (the area of the to-be-recognized object 50). The second bounding box 72 is a rectangular box on the be-recognized object 50, and the size of the second bounding box 72 approximately corresponds to the size of the to-be-recognized object 50.

Step S07-18 is to define a longest side length of the second bounding box 72 as the estimated maximum length according to the depth information of the depth image IM_DB. Understandably, the depth image IM_D comprises the depth information for the pixels. The depth information represents the relative distance between the depth sensor 412 and the to-be-recognized object 50. With reference to FIG. 17, the second bounding box 72 has a longest side length P1. For example, the second bounding box 72 is a rectangular box comprising a long side and a short side. The length of the long side is defined as the longest side length P1. Another example of the second bounding box 72 is a square box, such that the length of any side of the square box could be defined as the longest side length P1. Therefore, the processor 43 can compute the estimated maximum length of the to-be-recognized object 50 according to the depth information of the pixels on the longest side length P1 in the depth image. IM_D.

The object classification model training method and the computation device 10 of the present invention adopt the virtual object 3D models 111 of the model files 110 as the data source, and obtain the training datasets 112 respectively corresponding to the virtual object 3D models 111 by automatic image capturing of the revolving image-capture schedule 120. It is not necessary for the present invention to wait for the production of the physical components. It is not necessary for the present invention to spend most of time photographing the physical components to get the training samples. Therefore, to introduce artificial intelligence (AI) techniques into actual fields is much easier by the present invention. In another aspect, the present invention can exclude the 2D images without significant features to generate the training dataset 112, thereby promoting the training effect of the object classification model 30.

The object recognition device and the object recognition method of the present invention adopt the object classification model 30 obtained by the foregoing object classification model training method. Each 2D image generated via the revolving image-capture schedule 120 in the training method can simulate a certain position of the to-be-recognized object 50 photographed by the image capturing apparatus 41. Hence, regardless that whether the user takes the to-be-recognized object 50 by hand or not, regardless whether the to-be-recognized object 50 is a large component or not, and no matter from what angle the image capturing apparatus 41 is to photograph the to-be-recognized object 50, the object classification model 30 can effectively output the multiple options of the object candidates for the user to select. In another aspect, the present invention can compute the length of the to-be-recognized object 50 based on the image information of the depth image IM_D, and further exclude the object candidate(s) whose size(s) is/are more different than others from the candidate field 62 accordingly to promote the recognition effect.

For example, the image capturing apparatus 41 and the monitor 42 may be mounted on the MR headset. At the site of assembling a machine, the engineer could wear the MR headset and photograph any component on the site. Then, the engineer will rapidly find the corresponding object candidate from the candidate field 62 displayed on the monitor 42. The monitor 42 may display the specification data of such object candidate for the engineer to check and review. Therefore, the present invention may assist the engineer in rapidly checking and reviewing the components of the machine, to promote the whole working efficiency.

What is claimed is:

1. An object classification model training method performed by a computation device and comprising steps as follows:
reading multiple model files, wherein each model file comprises a virtual object three-dimensional (3D) model;
generating multiple two-dimensional (2D) images of the virtual object 3D model of each model file by a revolving image-capture schedule, wherein the multiple 2D images respectively have different contents corresponding to different positions of the virtual object 3D model of each model file;
generating a training dataset according to the multiple 2D images corresponding to the virtual object 3D model of each model file; and
training a to-be-trained model by the training dataset corresponding to the virtual object 3D model of each model file to obtain an object classification model.

2. The training method as claimed in claim 1, wherein image capturing configuration data of the revolving image-capture schedule comprises at least one object fixed axis, at least one axis of revolution, and at least one image capturing frequency.

3. The training method as claimed in claim 1, wherein the step of generating the training dataset comprises steps as follows:
computing a ratio of a size of a virtual object in each 2D image to an image size of the 2D image;
sorting the multiple 2D images according to the ratios of the multiple 2D images; and
generating the training dataset by the 2D image with the ratio higher than or equal to a threshold, and by the 2D image with the ratio lower than the threshold and complying with a filter condition, to exclude the 2D image without significant features for each model file.

4. The training method as claimed in claim 1, wherein
in the step of reading the multiple model files, each model file comprises size information of the virtual object 3D model; and
the step of generating the multiple 2D images of the virtual object 3D model of each model file by the revolving image-capture schedule comprises steps as follows:
determining whether the size information of the virtual object 3D model is greater than or equal to a threshold size;
if NO, storing a first preliminary image directly obtained by the revolving image-capture schedule as one of the multiple 2D images of the virtual object 3D model; and
if YES, recognizing at least one feature of the virtual object 3D model by a deep learning model and storing a second preliminary image of the at least one feature obtained by the revolving image-capture schedule as one of the multiple 2D images of the virtual object 3D model;
wherein a content of the first preliminary image is a whole virtual object, and a content of the second preliminary image is a portion that corresponds to the at least one feature of a virtual object.

5. A computation device for training an object classification model comprising:
a storage storing multiple model files, wherein each model file comprises a virtual object three-dimensional (3D) model; and
a processor electrically connected to the storage and performing steps as follows:
reading the multiple model files from the storage;
generating multiple two-dimensional (2D) images of the virtual object 3D model of each model file by a revolving image-capture schedule, wherein the multiple 2D images respectively have different contents corresponding to different positions of the virtual object 3D model of each model file;
generating a training dataset according to the multiple 2D images corresponding to the virtual object 3D model of each model file; and
training a to-be-trained model by the training dataset corresponding to the virtual object 3D model of each model file to obtain an object classification model.

6. The computation device as claimed in claim 5, wherein image capturing configuration data of the revolving image-capture schedule comprises at least one object fixed axis, at least one axis of revolution, and at least one image capturing frequency.

7. The computation device as claimed in claim 5, wherein the step of generating the training dataset by the processor comprises steps as follows:
computing a ratio of a size of a virtual object in each 2D image to an image size of the 2D image;
sorting the multiple 2D images according to the ratios of the multiple 2D images; and
generating the training dataset by the 2D image with the ratio higher than or equal to a threshold, and by the 2D image with the ratio lower than the threshold and complying with a filter condition, to exclude the 2D image without significant features for each model file.

8. The computation device as claimed in claim 5, wherein
in the step of reading the multiple model files by the processor, each model file comprises size information of the virtual object 3D model; and
the step of generating the multiple 2D images of the virtual object 3D model of each model file by the revolving image-capture schedule by the processor comprises steps as follows:
determining whether the size information of the virtual object 3D model is greater than or equal to a threshold size;
if NO, storing a first preliminary image directly obtained by the revolving image-capture schedule as one of the multiple 2D images of the virtual object 3D model; and
if YES, recognizing at least one feature of the virtual object 3D model by a deep learning model and storing a second preliminary image of the at least one feature obtained by the revolving image-capture schedule as one of the multiple 2D images of the virtual object 3D model;
wherein a content of the first preliminary image is a whole virtual object, and a content of the second preliminary image is a portion that corresponds to the at least one feature of a virtual object.

9. An object recognition device comprising:
an image capturing apparatus photographing a to-be-recognized object to generate an actual image having the to-be-recognized object;
a monitor; and
a processor signally connected to the image capturing apparatus and the monitor and performing steps as follows:
receiving the actual image from the image capturing apparatus;
inputting the actual image to the object classification model as claimed in claim 1 for the object classification model to output multiple object candidates according to the to-be-recognized object of the actual image, wherein each object candidate has an accuracy;
sorting the multiple object candidates according to the accuracies to generate a sort list of the multiple object candidates; and
controlling the monitor to display at least one of the object candidates that has the accuracy higher than a preset ratio in the sort list.

10. The device as claimed in claim 9, wherein
each object candidate has a reference length;
the image capturing apparatus comprises:
a color camera generating the actual image; and
a depth sensor sensing the to-be-recognized object to generate a depth image including the to-be-recognized object;
the processor computes an estimated maximum length of the to-be-recognized object according to the actual image and the depth image; and
the processor rearranges the multiple object candidates in the sort list according to differences among the reference lengths of the object candidates and the estimated maximum length, and controls the monitor to display top N of the object candidates with the accuracy higher than the preset ratio in the rearranged sort list, wherein N is a positive integer higher than or equal to 1.

11. The device as claimed in claim 10, wherein
the multiple object candidates in the sort list are in a descending order according to the accuracies;
the processor rearranging the multiple object candidates in the sort list is to determine whether an absolute difference value between the reference length of each object candidate and the estimated maximum length is lower than or equal to an error upper limit; and if not so, the processor arranges such object candidate to a bottom of the sort list.

12. The device as claimed in claim 10, wherein the step of computing the estimated maximum length by the processor comprises steps as follows:
determining whether the actual image has a human-skin feature;
when the processor determines the actual image does not have the human-skin feature, the processor performs steps as follows:
recognizing the to-be-recognized object in the depth image to generate a first bounding box for the to-be-recognized object; and
defining a longest side length of the first bounding box as the estimated maximum length according to depth information of the depth image;
when the processor determines the actual image has the human-skin feature, the processor performs steps as follows:
converting the actual image to a first binary image comprising a human-skin area and a non-human-skin area;
converting the depth image to a second binary image, comprising the to-be-recognized object, a human-skin area, and a background area, according to the depth information of the depth image;
performing an image coordinate transformation for the first binary image and the second binary image to have consistent coordinate systems;
comparing image contents of the first binary image and the second binary image to recognize the to-be-recognized object in the second binary image to generate a second bounding box for the to-be-recognized object; and
defining a longest side length of the second bounding box as the estimated maximum length according to the depth information of the depth image.

13. An object recognition method performed by a processor and comprising steps as follows:
receiving an actual image from an image capturing apparatus;
inputting the actual image to the object classification model as claimed in claim 1 for the object classification model to output multiple object candidates according to the to-be-recognized object of the actual image, wherein each object candidate has an accuracy;
sorting the multiple object candidates according to the accuracies to generate a sort list of the multiple object candidates; and
controlling a monitor to display at least one of the object candidates that has the accuracy higher than a preset ratio in the sort list.

14. The method as claimed in claim 13 further comprising steps as follows:
receiving a depth image from the image capturing apparatus;
computing an estimated maximum length of the to-be-recognized object according to the actual image and the depth image; and
rearranging the multiple object candidates in the sort list according to differences among reference lengths of the object candidates and the estimated maximum length, and controlling the monitor to display a preset number of the object candidates with the accuracy higher than the preset ratio in the rearranged sort list.

15. The method as claimed in claim 14, wherein
the multiple object candidates in the sort list are in a descending order according to the accuracies;
the processor rearranging the multiple object candidates in the sort list is to determine whether an absolute difference value between the reference length of each object candidate and the estimated maximum length is lower than or equal to an error upper limit; and if not so, the processor arranges such object candidate to a bottom of the sort list.

16. The method as claimed in claim 14, wherein the step of computing the estimated maximum length by the processor comprises steps as follows:
determining whether the actual image has a human-skin feature;
when the processor determines the actual image does not have the human-skin feature, the processor performs steps as follows:
recognizing the to-be-recognized object in the depth image to generate a first bounding box for the to-be-recognized object; and
defining a longest side length of the first bounding box as the estimated maximum length according to depth information of the depth image;
when the processor determines the actual image has the human-skin feature, the processor performs steps as follows:
converting the actual image to a first binary image comprising a human-skin area and a non-human-skin area;
converting the depth image to a second binary image, comprising the to-be-recognized object, a human-skin area, and a background area, according to the depth information of the depth image;
performing an image coordinate transformation for the first binary image and the second binary image to have consistent coordinate systems;
comparing image contents of the first binary image and the second binary image to recognize the to-be-recognized object in the second binary image to generate a second bounding box for the to-be-recognized object; and
defining a longest side length of the second bounding box as the estimated maximum length according to the depth information of the depth image.
